(19) United States
(12) Patent Application Publication
(10) Pub. No.: US 2024/0021017 A1
(43) Pub. Date: Jan. 18, 2024

(54) KINSHIP VERIFICATION METHOD BASED ON GENERALIZED MULTI-VIEW GRAPH EMBEDDING

(71) Applicant: Shanxi University, Shanxi (CN)

(72) Inventors: Jianqing LIANG, Shanxi (CN); Jiye LIANG, Shanxi (CN)

(73) Assignee: Shanxi University, Shanxi (CN)

(21) Appl. No.: 18/216,765

(22) Filed: Jun. 30, 2023

(30) Foreign Application Priority Data
Jul. 13, 2022 (CN) 202210856270.7

(51) Int. Cl. G06V 40/16; G06V 10/80

(52) U.S. Cl. CPC G06V 40/172; G06V 40/168; G06V 10/80

(57) ABSTRACT

The present disclosure provides a kinship verification method based on generalized multi-view graph embedding, including the following steps: extracting features for multiple views of facial images from a training set and generating sample pair; constructing an intrinsic graph and a penalty graph of each of the multiple views based on semantic information, and converting and correcting a graph embedding method; implementing generalized fusion for the multiple views, and solving generalized eigenvalue decomposition; and calculating a similarity between the facial images, and outputting a kinship discrimination result. The present disclosure tackles challenges of scarce samples, numerous interference factors, small individual differences, and so on in the related art, provides a novel generalized multi-view metric learning method capable of accurately depicting relative differences between different individuals and making full use of consistency and complementarity between multiple views, and complete face-based kinship verification effectively and efficiently.

### CROSS REFERENCE TO RELATED APPLICATION

This patent application claims the benefit and priority of Chinese Patent Application No. 202210856270.7, filed with the China National Intellectual Property Administration on Jul. 13, 2022, the disclosure of which is incorporated by reference herein in its entirety as part of the present application.

### TECHNICAL FIELD

The present disclosure belongs to the technical field of paternity identification, and in particular to a kinship verification method based on generalized multi-view graph embedding.

### BACKGROUND

Related research on signal processing indicates that human appearances may provide valuable clues for biological relation prediction. Face-based kinship verification has advantages of high efficiency and low cost over biological deoxyribonucleic acid (DNA) identification, and has become an emerging and interesting research task in computer vision in recent years. By measuring similarities between facial appearances, the task has been widely applied to identity identification, social media analysis and other scenarios. Compared with conventional face verification, the task not only is affected by such factors as expressions, postures and illumination, but also shows significant differences in gender and age. In addition, complicated relation among multiple entities and limited data sizes pose great challenges to related art. Hence, it is eager to develop effective and robust feature representation and metric learning methods, to improve performance and efficiency in the kinship verification.

### SUMMARY

The present disclosure provides a kinship verification method based on generalized multi-view graph embedding, which can accurately depict relative differences between different individuals, makes full use of consistency and complementarity between multiple views to implement generalized fusion for the multiple views, and thus complete face-based kinship verification effectively and efficiently.

To achieve the above-mentioned objective, the present disclosure adopts the following technical solutions: A kinship verification method based on generalized multi-view graph embedding specifically includes:
step 101: extracting features for multiple views of facial images from a training set and generating a sample pair;
step 102: constructing an intrinsic graph and a penalty graph of each of the multiple views based on semantic information, and converting and correcting a graph embedding method;
step 103: implementing generalized fusion for the multiple views, and solving generalized eigenvalue decomposition; and
step 104: calculating a similarity between the facial images, and outputting a kinship discrimination result.

Optionally, the extracting features for multiple views of facial images from a training set and generating a sample pair in step 101 further include:
transmitting the training set to a local feature histogram of gradients (HOG), a scale-invariant feature transform (SIFT) feature descriptor and a deep convolutional neural network (DCNN), obtaining 500-dimension bag-of-words (BoW) representations and 1,024-dimension deep features of the images through a BoW model and a final fully-connected (FC) layer of a feature extraction network respectively, performing principal component analysis (PCA) dimensionality reduction to obtain a 200-dimension feature representation X^{(v)}∈R^{d×N}, v=1, 2, . . . , m of each of the views, and obtaining a similar sample pair set S^{(v)}={(xᵢ^{(v)}, yᵢ^{(v)}|i=1, 2, . . . , N}, v=1, 2, . . . , m and a dissimilar sample pair set D^{(v)}={(xᵢ^{(v)}, yⱼ^{(v)})|i=1, 2, . . . , N, j≠i}, v=1, 2, . . . , m of the view according to sample labels.

Optionally, in response to the constructing an intrinsic graph and a penalty graph of each of the multiple views based on semantic information in step 102, an objective function is given by:

$${max}_{{U}^{( v )}} \frac{tr \text{[(} {U}^{( v )} {)}^{T} ( {D}^{( v )} + α {D}_{x}^{( v )} + β {D}_{y}^{( v )} ) {U}^{( v )} ]}{tr \text{[(} {U}^{( v )} {)}^{T} {S}^{( v )} {U}^{( v )} ]} , s . t . ( {U}^{( v )} {)}^{T} {U}^{( v )} = I , v = 1 , 2 , … , m$$

where, U^{(v)}∈R^{D×d}(d<<D) is a feature transformation matrix of a view v,

$${S}^{( v )} = \frac{1}{N} {\sum }_{( {x}_{i}^{( v )} , {y}_{i}^{( v )} ) ∈ {S}^{( v )}} ( {x}_{i}^{( v )} - {y}_{i}^{( v )} ) ( {x}_{i}^{( v )} - {y}_{i}^{( v )} {)}^{T}$$

is an average intraclass scatter matrix of the view v,

$${D}^{( v )} = \frac{1}{N} {\sum }_{( {x}_{i}^{( v )} , {y}_{j}^{( v )} ) ∈ {D}^{( v )}} ( {x}_{i}^{( v )} - {y}_{j}^{( v )} ) ( {x}_{i}^{( v )} - {y}_{j}^{( v )} {)}^{T}$$

is an average interclass scatter matrix of the view v,

$${D}_{x}^{( v )} = \frac{1}{N K} {{\sum }_{( {x}_{i}^{( v )} , {y}_{i}^{( v )} ) ∈ {S}^{( v )}}}_{{y}_{k}^{( v )} ∈ {N}_{K} ( {y}_{i}^{( v )} )} ( {x}_{i}^{( v )} - {y}_{k}^{( v )} ) ( {x}_{i}^{( v )} - {y}_{k}^{( v )} {)}^{T}$$

is an average interclass scatter matrix of a K-nearest neighbor (KNN) sample pair (xᵢ^{(v)}, yₖ^{(v)}) of the view v,

$${D}_{y}^{( v )} = \frac{1}{N K} {{\sum }_{( {x}_{i}^{( v )} , {y}_{i}^{( v )} ) ∈ {S}^{( v )}}}_{{x}_{k}^{( v )} ∈ {N}_{K} ( {x}_{i}^{( v )} )} ( {x}_{k}^{( v )} - {y}_{i}^{( v )} ) ( {x}_{k}^{( v )} - {y}_{i}^{( v )} {)}^{T}$$

is an average interclass scatter matrix of a KNN sample pair (xₖ^{(v)}, yᵢ^{(v)}) of the view v, a and p are a balance parameter for controlling the interclass scatter matrix D^{(v)}, Dₓ^{(v)}, D_{y}^{(v)}, and I is a d×d unit matrix.

Optionally, in response to the converting a graph embedding method, a non-convex optimization form of a trace ratio problem may be converted into an alternative ratio trace problem:

$${max}_{{U}^{( v )}} tr \text{[((} {U}^{( v )} {)}^{T} {S}^{( v )} {U}^{( v )} {)}^{- 1} ( {U}^{( v )} {)}^{T} ( {D}^{( v )} + α {D}_{x}^{( v )} + β {D}_{y}^{( v )} ) {U}^{( v )} ] ,$$

the problem above may be solved through generalized eigenvalue decomposition

(D^{(v)}+αDₓ^{(v)}+βD_{y}^{(v)})u^{(v)}=λS^{(v)}u^{(v)},

and
when d>N, and a matrix S^{(v)} becomes near-singular, the eigenvalue decomposition has no solution; and in order to overcome the defect, the graph embedding method is corrected by adding a unit matrix as a regularizer:

$${S}^{( v )} = ( 1 - γ ) {S}^{( v )} + γ \frac{t r ( {S}^{( v )} )}{N} I ,$$

where 0≤γ≤1 is a regularization parameter.

Optionally, in response to the implementing generalized fusion for the multiple views in step 103, an objective function is given by:

$${max}_{u} {u}^{T} Ã u$$

$$s . t . {u}^{T} \overline{B} u = 1$$

generalized eigenvalue decomposition is solved, and a problem may be solved through the generalized eigenvalue decomposition

$$Ã û = λ Ã û where {û}^{T} = [ {û}_{1}^{T} , {û}_{2}^{T} , … , {û}_{m}^{T} ] ,$$

$$Ã = [ \begin{matrix}{A}_{1} & {ω}_{12} {Z}_{1} {Z}_{2}^{T} & … & {ω}_{1 m} {Z}_{1} {Z}_{m}^{T} \\ {ω}_{12} {Z}_{2}^{T} {Z}_{1} & {θ}_{2} {A}_{2} & … & {ω}_{2 m} {Z}_{2} {Z}_{m}^{T} \\ ⋮ & ⋮ & ⋱ & ⋮ \\ {ω}_{1 m} {Z}_{m}^{T} {Z}_{1} & {ω}_{2 m} {Z}_{m}^{T} {Z}_{2} & … & {θ}_{m} {A}_{m}\end{matrix} ] ,$$

$$\tilde{B} = [ \begin{matrix}{B}_{1} & 0 & … & 0 \\ 0 & {η}_{2} {B}_{2} & … & 0 \\ ⋮ & ⋮ & ⋱ & ⋮ \\ 0 & 0 & … & {η}_{m} {B}_{m}\end{matrix} ]$$

is a symmetric matrix, Aᵥ=D^{(v)}+αDₓ^{(v)}+βD_{y}^{(v)}, Bᵥ=S^{(v)}, Zᵥ=X^{(v)}=1, 2, . . . , m.

Optionally, the calculating a similarity between the facial images, and outputting a kinship discrimination result in step 104 further include:
calculating a similarity between the paired facial images with a cosine similarity, comparing the similarity with a given threshold (0.5), and outputting the discrimination result.

The kinship verification method provided by the present disclosure tackles challenges of scarce samples, numerous interference factors, small individual differences, and so on in the related art, can accurately depict relative differences between different individuals, make full use of consistency and complementarity between multiple views to implement generalized fusion for the multiple views, and complete face-based kinship verification effectively and efficiently.

### BRIEF DESCRIPTION OF THE DRAWINGS

FIG. 1 illustrates a kinship verification method based on generalized multi-view graph embedding according to an embodiment of the present disclosure.

### DETAILED DESCRIPTION OF THE EMBODIMENTS

To make a person skilled in the art better understand the solutions of the present disclosure, the following clearly and completely describes the technical solutions in the embodiments of the present disclosure with reference to the accompanying drawings in the embodiments of the present disclosure. Apparently, the described embodiments are only a part of, not all of, the embodiments of the present disclosure. All other embodiments obtained by a person of ordinary skill in the art based on the embodiments of the present disclosure without creative efforts shall fall within the protection scope of the present disclosure.

With reference to the accompanying drawing, an embodiment of the present disclosure provides a kinship verification method based on generalized multi-view graph embedding.

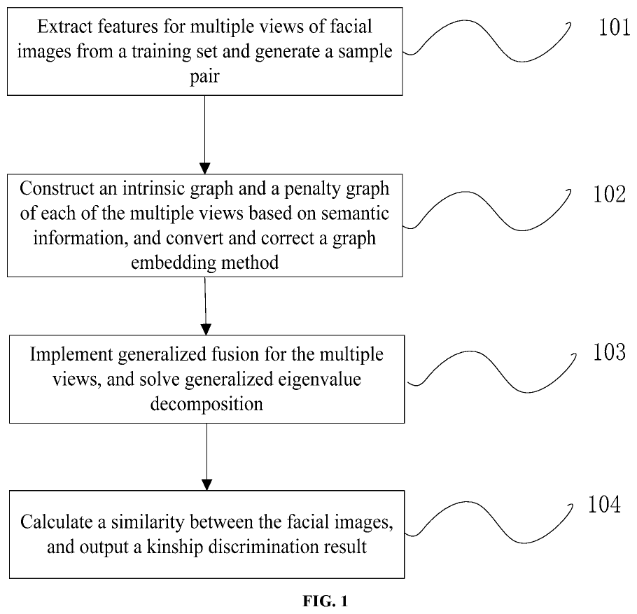

As shown in FIG. 1, the kinship verification method based on generalized multi-view graph embedding includes the following steps:

Step 101: Extract features for multiple views of facial images from a training set and generate a sample pair.

Transmit the training set to a local feature HOG, an SIFT feature descriptor and a DCNN, obtain 500-dimension BoW representations and 1,024-dimension deep features of the images through a BoW model and a final FC layer of a feature extraction network respectively, perform principal component analysis (PCA) dimensionality reduction to obtain a 200-dimension feature representation X^{(v)}∈R^{d×N}, v=1, 2, . . . , m of each of the views, and obtain a similar sample pair set S^{(v)}={(xᵢ^{(v)}, yᵢ^{(v)}=1, 2, . . . , N}, v=1, 2, . . . , m and a dissimilar sample pair set D^{(v)}={(xᵢ^{(v)}, yᵢ^{(v)} i=1, 2, . . . , N, j≠i}, v=1, 2, . . . , m of the view according to sample labels.

Step 102: Construct an intrinsic graph and a penalty graph of each of the multiple views based on semantic information, and convert and correct a graph embedding method.

For a view v=1, 2, . . . , m, an objective function is given by:

$${max}_{{U}^{( v )}} \frac{tr \text{[(} {U}^{( v )} {)}^{T} ( {D}^{( v )} + α {D}_{x}^{( v )} + β {D}_{y}^{( v )} ) {U}^{( v )} ]}{tr \text{[(} {U}^{( v )} {)}^{T} {S}^{( v )} {U}^{( v )} ]} , s . t . ( {U}^{( v )} {)}^{T} {U}^{( v )} = I$$

where, U^{(v)}∈R^{D×d}(d<<D) a feature transformation matrix of the view v,

$${S}^{( v )} = \frac{1}{N} {\sum }_{( {x}_{i}^{( v )} , {y}_{i}^{( v )} ) ∈ {S}^{( v )}} ( {x}_{i}^{( v )} - {y}_{i}^{( v )} ) ( {x}_{i}^{( v )} - {y}_{i}^{( v )} {)}^{T}$$

is an average intraclass scatter matrix of the view v,

$${D}^{( v )} = \frac{1}{N} {\sum }_{( {x}^{( v )} , {y}_{i}^{( v )} ) ∈ {D}^{( v )}} ( {x}_{i}^{( v )} - {y}_{j}^{( v )} ) ( {x}_{i}^{( v )} - {y}_{j}^{( v )} {)}^{T}$$

is an average interclass scatter matrix of the view v,

$${D}_{x}^{( v )} = \frac{1}{N K} {\sum }_{\begin{matrix}( {x}_{i}^{( v )} , {y}_{i}^{( v )} ) \\ {y}_{k}^{( v )} ∈ {N}_{K} ( {y}_{i}^{( v )} )\end{matrix}} ( {x}_{i}^{( v )} - {y}_{k}^{( v )} ) {( {x}_{i}^{( v )} - {y}_{k}^{( v )} )}^{T}$$

is an average interclass scatter matrix of a KNN sample pair (xᵢ^{(v)}, yₖ^{(v)}) of the view v,

$${D}_{y}^{( v )} = \frac{1}{N K} {\sum }_{\begin{matrix}( {x}_{i}^{( v )} - {y}_{i}^{( v )} ) ∈ {S}^{( v )} \\ {x}_{k}^{( v )} ∈ {N}_{K} ( {x}_{i}^{( v )} )\end{matrix}} ( {x}_{k}^{( v )} - {y}_{i}^{( v )} ) {( {x}_{k}^{( v )} - {y}_{i}^{( v )} )}^{T}$$

is an average interclass scatter matrix of a KNN sample pair (xₖ^{(v)}, yᵢ^{(v)}) of the view v, α and β are balance parameters for controlling the interclass scatter matrix D^{(v)}, Dₓ^{(v)}, D_{y}^{(v)} and I is a d×d unit matrix.

To convert the graph embedding method, a non-convex optimization form of a trace ratio problem may be converted into an alternative ratio trace problem:

$${max}_{{U}^{( v )}} tr [ {( {( {U}^{( v )} )}^{T} {S}^{( v )} {U}^{( v )} )}^{- 1} {( {U}^{( v )} )}^{T} ( {D}^{( v )} + α {D}_{x}^{( v )} + β {D}_{y}^{( v )} ) {U}^{( v )} ] ,$$

The problem may be solved through generalized eigenvalue decomposition

(D^{(v)}+αDₓ^{(v)}+βD_{y}^{(v)})u^{(v)}=λS^{(v)}u^{(v)},

When d>N, and a matrix S^{(v)} becomes near-singular, the eigenvalue decomposition has no solution. In order to overcome the defect, the graph embedding method is corrected by adding a unit matrix as a regularizer:

$${S}^{( v )} = ( 1 - γ ) {S}^{( v )} + γ \frac{t r ( {S}^{( v )} )}{N} I ,$$

where 0≤γ≤1 is a regularization parameter.

Step 103: Implement generalized fusion for the multiple views, and solve generalized eigenvalue decomposition.

A specific objective function is given by:

$${max}_{u} {u}^{T} \tilde{A} u$$

$$s . t . {u}^{T} \tilde{B} u = 1$$

Generalized eigenvalue decomposition is solved, and a problem may be solved through the generalized eigenvalue decomposition

Ãû=λ\tilde{B}û
where, λ₁≥λ₂≥ . . . ≥Δ_{d′} denotes top d′ largest eigenvalues, û^{T}=[û₁^{T}, û₂^{T}, . . . , ûₘ^{T}] is a transformation matrix which is composed of corresponding eigenvectors, and maps data from an original feature space R^{d} to a new low-dimensional space R^{d′}, d′=100, and A_{T} Z 0

$$\tilde{A} = [ \begin{matrix}{A}_{1} & {ω}_{12} {Z}_{1} {Z}_{2}^{T} & … & {ω}_{1 m} {Z}_{1} {Z}_{m}^{T} \\ {ω}_{12} {Z}_{2}^{T} {Z}_{1} & {θ}_{2} {A}_{2} & … & {ω}_{2 m} {Z}_{2} {Z}_{m}^{T} \\ ⋮ & ⋮ & ⋱ & ⋮ \\ {ω}_{1 m} {Z}_{m}^{T} {Z}_{1} & {ω}_{2 m} {Z}_{m}^{T} {Z}_{2} & … & {θ}_{m} {A}_{m}\end{matrix} ] ,$$

$$\tilde{B} = [ \begin{matrix}{B}_{1} & 0 & … & 0 \\ 0 & {η}_{2} {B}_{2} & … & 0 \\ ⋮ & ⋮ & ⋱ & ⋮ \\ 0 & 0 & … & {η}_{m} {B}_{m}\end{matrix} ]$$

is a symmetric matrix, Aᵥ=D^{(v)}+αDₓ^{(v)}+βD_{y}^{(v)}, Bᵥ=S^{(v)}, and Zᵥ=X^{(v)}, v=1, 2, . . . , m.

Step 104: Calculate a similarity between the facial images, and output a kinship discrimination result.

Calculate a similarity between the paired facial images with a cosine similarity, compare the similarity with a given threshold (0.5), and output the discrimination result.

Finally, it should be noted that the above embodiments are merely intended to describe the technical solutions of the present disclosure, rather than to limit the present disclosure. Although the present disclosure is described in detail with reference to the above embodiments, a person of ordinary skill in the art should understand that they may still make modifications to the technical solutions described in the above embodiments or make equivalent replacements to some or all technical features thereof, without departing from the essence of the technical solutions in the embodiments of the present disclosure.

What is claimed is:

1. A kinship verification method based on generalized multi-view graph embedding, comprising the following steps:
step 101: extracting features for multiple views of facial images from a training set and generating a sample pair;
step 102: constructing an intrinsic graph and a penalty graph of each of the multiple views based on semantic information, and converting and correcting a graph embedding method;
step 103: implementing generalized fusion for the multiple views, and solving generalized eigenvalue decomposition; and
step 104: calculating a similarity between the facial images, and outputting a kinship discrimination result.

2. The kinship verification method based on generalized multi-view graph embedding according to claim 1, wherein the extracting features for multiple views of facial images from a training set and generating a sample pair in step 101 further comprise:
transmitting the training set to a local feature histogram of gradients (HOG), a scale-invariant feature transform (SIFT) feature descriptor and a deep convolutional neural network (DCNN), obtaining 500-dimension bag-of-words (BoW) representations and 1,024-dimension deep features of the images through a BoW model and a final fully-connected (FC) layer of a feature extraction network respectively, performing principal component analysis (PCA) dimensionality reduction to obtain a 200-dimension feature representation X^{(v)}∈R^{d×N}, v=1, 2, . . . , m of each of the views, and obtaining a similar sample pair set S^{(v)}={(xᵢ^{(v)}, yᵢ^{(v)})|i=1, 2, . . . , N}, v=1, 2, . . . , m and a dissimilar sample pair set D^{(v)}={(xᵢ^{(v)}, yⱼ^{(v)})|i=1, 2, . . . , N, j≠i}, v=1, 2, . . . , m of the view according to sample labels.

3. The kinship verification method based on generalized multi-view graph embedding according to claim 1, wherein in response to the constructing an intrinsic graph and a penalty graph of each of the multiple views based on semantic information in step 102, an objective function is given by:
$${max}_{{U}^{( v )}} \frac{t r [ {( {U}^{( v )} )}^{T} ( {D}^{( v )} + α {D}_{x}^{( v )} + β {D}_{y}^{( v )} ) {U}^{( v )} ]}{t r [ {( {U}^{( v )} )}^{T} {S}^{( v )} {U}^{( v )} ]} ,$$
$$s . t . {( {U}^{( v )} )}^{T} {U}^{( v )} = I , v = 1 , 2 , … , m$$
$$wherein , {U}^{( v )} ∈ {R}^{D \times d} ( d ≪ D )$$
is a feature transformation matrix of a view v,
$${S}^{( v )} = \frac{1}{N} {\sum }_{( {x}_{i}^{( v )} , {y}_{i}^{( v )} ) ∈ {S}^{( v )}} ( {x}_{i}^{( v )} - {y}_{i}^{( v )} ) {( {x}_{i}^{( v )} - {y}_{i}^{( v )} )}^{T}$$
is an average intraclass scatter matrix of the view v,
$${D}^{( v )} = \frac{1}{N} {\sum }_{( {x}_{i}^{( v )} , {y}_{i}^{( v )} ) ∈ {D}^{( v )}} ( {x}_{i}^{( v )} - {y}_{j}^{( v )} ) {( {x}_{i}^{( v )} - {y}_{j}^{( v )} )}^{T}$$
is an average interclass scatter matrix of the view v,
$${D}_{x}^{( v )} = \frac{1}{N K} {\sum }_{\begin{matrix}( {x}_{i}^{( v )} , {y}_{i}^{( v )} ) ∈ {S}^{( v )} \\ {y}_{k}^{( v )} ∈ {N}_{K} ( {y}_{i}^{( v )} )\end{matrix}} ( {x}_{i}^{( v )} - {y}_{k}^{( v )} ) {( {x}_{i}^{( v )} - {y}_{k}^{( v )} )}^{T}$$
is an average interclass scatter matrix of a K-nearest neighbor (KNN) sample pair (xᵢ^{(v)}, yₖ^{(v)}) of the view v,
$${D}_{y}^{( v )} = \frac{1}{N K} {\sum }_{\begin{matrix}( {x}_{i}^{( v )} , {y}_{i}^{( v )} ) ∈ {S}^{( v )} \\ {y}_{k}^{( v )} ∈ {N}_{K} ( {x}_{i}^{( v )} )\end{matrix}} ( {x}_{k}^{( v )} - {y}_{i}^{( v )} ) {( {x}_{k}^{( v )} - {y}_{i}^{( v )} )}^{T}$$
is an average interclass scatter matrix of a KNN sample pair (xₖ^{(v)}, yᵢ^{(v)}) of the view v, a and § are balance parameters for controlling the interclass scatter matrix D^{(v)}, Dₓ^{(v)}, D_{y}^{(v)}, and I is a d×d unit matrix.

4. The kinship verification method based on generalized multi-view graph embedding according to claim 1, wherein in response to the converting a graph embedding method in step 102, a non-convex optimization form of a trace ratio problem is converted into an alternative ratio trace problem:
$${max}_{{U}^{( v )}} tr [ {( {( {U}^{( v )} )}^{T} S ( v ) {U}^{( v )} )}^{- 1} {( {U}^{( v )} )}^{T} ( {D}^{( v )} + α {D}_{x}^{( v )} + β {D}_{y}^{( v )} ) {U}^{( v )} ] ,$$
the above problem is solved through generalized eigenvalue decomposition (D^{(v)}+αDₓ^{(v)}+βD_{y}^{(v)})u^{(v)}=λS^{(v)}u^{(v)}, and
when d>N, and a matrix S^{(v)} becomes near-singular, the eigenvalue decomposition has no solution; and in order to overcome the defect, the graph embedding method is corrected by adding a unit matrix as a regularizer:
$${S}^{( v )} = ( 1 - γ ) {S}^{( v )} + γ \frac{t r ( {S}^{( v )} )}{N} I ,$$
$$wherein 0 \leq γ \leq 1$$
is a regularization parameter.

5. The kinship verification method based on generalized multi-view graph embedding according to claim 1, wherein in response to the implementing generalized fusion for the multiple views in step 103, an objective function is given by:
$${max}_{u} {u}^{T} \tilde{A} u$$
$$s . t . {u}^{T} \tilde{B} u = 1$$
and
generalized eigenvalue decomposition is solved, and a problem is solved through the generalized eigenvalue decomposition
$$\tilde{A} \hat{u} = λ \tilde{B} \hat{u}$$
$$wherein , {\hat{u}}^{T} = [ {\hat{u}}_{1}^{T} , {\hat{u}}_{2}^{T} , … , {\hat{u}}_{m}^{T} ] ,$$
$$\tilde{A} = [ \begin{matrix}{A}_{1} & {ω}_{12} {Z}_{1} {Z}_{2}^{T} & … & {ω}_{1 m} {Z}_{1} {Z}_{m}^{T} \\ {ω}_{12} {Z}_{2}^{T} {Z}_{1} & {θ}_{2} {A}_{2} & … & {ω}_{2 m} {Z}_{2} {Z}_{m}^{T} \\ ⋮ & ⋮ & ⋱ & ⋮ \\ {ω}_{1 m} {Z}_{m}^{T} {Z}_{1} & {ω}_{2 m} {Z}_{m}^{T} {Z}_{2} & … & {θ}_{m} {A}_{m}\end{matrix} ] ,$$
$$\tilde{B} = [ \begin{matrix}{B}_{1} & 0 & … & 0 \\ 0 & {η}_{2} {B}_{2} & … & 0 \\ ⋮ & ⋮ & ⋱ & ⋮ \\ 0 & 0 & … & {η}_{m} {B}_{m}\end{matrix} ]$$
is a symmetric matrix, Aᵥ=D^{(v)}+αD^{(v)}+βD_{y}^{(v)}, Bᵥ=S^{(v)}, and Zᵥ=X^{(v)}, v=1, 2, . . . , m.

6. The kinship verification method based on generalized multi-view graph embedding according to claim 1, wherein the calculating a similarity between the facial images, and outputting a kinship discrimination result in step 104 further comprise: calculating a similarity between the paired facial images with a cosine similarity, comparing the similarity with a given threshold (0.5), and outputting the discrimination result.
